(19) United States
(12) Patent Application Publication
(10) Pub. No.: US 2015/0262126 A1
(43) Pub. Date: Sep. 17, 2015

(54) METHOD AND SYSTEM FOR AGGREGATING RECORDS FOR A PROJECT FROM DISPARATE DATABASES

(71) Applicant: POPLICUS INC., San Francisco, CA (US)

(72) Inventors: ERIC GILLESPIE, San Francisco, CA (US); Wook Nam, San Francisco, CA (US); Eric Schatz, San Francisco, CA (US); Geoff Celhar, San Francisco, CA (US)

(21) Appl. No.: 14/213,875

(22) Filed: Mar. 14, 2014

(51) Int. Cl. G06Q 10/10; G06F 17/30

(52) U.S. Cl. CPC G06Q 10/10; G06F 17/30091; G06F 17/30598

(57) ABSTRACT

A system and method for project information management are shown involving collecting multiple records from disparate databases through the network, where the records relating to project information, normalizing the collected records to a predetermined format, analyzing fields of each normalized record to identify a record type and search values for searching for a related record. For each related record, associate the record with the related record, store the records and their association, and provide an interface to display a selected record and its relationship to associated records.

### TECHNICAL FIELD

Aspects of the disclosure are related to computer hardware and software and, in particular, to project information management.

### BACKGROUND

Large projects, such as for governmental entities, typically have a variety of records relating to different phases and aspects of the project. For example, an initiation phase of a project may include records for a business case, feasibility studies, advance notice, solicitation of proposals, amendments to the solicitation, bid proposals, and award notices. A planning phase may include records relating to a project plan, resource plan, deliverable plan, financial plan, quality plan, acceptance plan, and communications plan. An execution phase may include records relating to awards of contracts, deliverables, task orders, government delivery schedules, scope, costs, quality, inspection and other issues. A closure phase may include records relating to turnover of deliverables, quality and post implementation review. These sorts of project records often reside in different databases.

Governmental entities issue solicitations or requests for proposals (RFPs) when they want to procure goods, commodities, assets or services. These typically include written descriptions and requirements for the products or services, such as schedule, quality, or cost. The United States government, for instance, procures hundreds of billions of dollars in goods and services each year. The government publishes its needs through a variety of media, such as fbo.gov, sba.gov and the Commerce Business Daily. The services for which the government contracts are wide-ranging and include transportation, professional services, and real estate.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Examples of a project information management system are shown wherein one or more servers are communicatively coupled to a computer communication network. The system in operation communicates with a plurality of services through the network to collect multiple records from disparate databases, where the multiple records relate to project information and normalizes the collected records to a predetermined data format. For each normalized collected record, multiple fields of the record are analyzed to identify a type for the record and identify search values for searching for a related record. The system searches for one or more related records, and, for each related record found, associates the record with the related record. The records and their association with one another are stored to facilitate retrieval of the records and their associations. The system provides an interface to the stored records that displays, for a selected record, the record, the associated records, and the relationships between the records.

In a further example, the types for the records include at least one of a master contract, a term contract, and a task order, and the system stores the records and their association with one another by storing each term contract record with the term contract record's association with a master contract record and storing each task order record with the task record's association with at least one of a master contract and a term contract.

In other examples, the interface to the stored records provides access to a selected master contract record along with at least one associated term contract record as well as access to at least one task record associated with the associated term contract records. In a further refinement of this example, the interface also displays in a hierarchical manner the selected master contract record along with the associated term contract record as well as the task record data associated with the associated term contract records.

In another example, the multiple fields of the record analyzed to identify a type for the record and identify search values for searching for a related record include at least one of an action type, a contract date, an agency identifier, a project number field, and a secondary project number field.

The foregoing and other objectives, features, and advantages of the invention will be more readily understood upon consideration of the following detailed description of the invention taken in conjunction with the accompanying drawings.

### BRIEF DESCRIPTION OF THE DRAWINGS

Various embodiments in accordance with the present disclosure will be described with reference to the drawings, in which:

FIG. 1 is a schematic diagram depicting aspects of one example of a networked computing environment having multiple sources of project data and a comprehensive data interface server in which some embodiments of the invention may be implemented;

FIG. 2 is a control flow diagram illustrating an example of a process for collecting and mapping records to projects in accordance with at least one embodiment of the invention;

FIG. 3 is a control flow diagram illustrating an example of a process for normalizing records in the process of FIG. 2 and in accordance with at least one embodiment of the invention;

FIG. 4 is a control flow diagram illustrating an example of a process for mapping records to projects in the process of FIG. 2 and in accordance with at least one embodiment of the invention;

FIG. 5 is a schematic diagram illustrating examples of records that may be matched utilizing certain embodiments of the invention;

FIG. 6 is a control flow diagram illustrating an example of a process for mapping federal governmental records in accordance with at least one embodiment of the invention;

FIG. 7 is a schematic diagram depicting examples of project information records suitable for application of certain embodiments of the present invention;

FIG. 8 is a schematic diagram depicting one example of a relationship between records mapped in accordance with at least one embodiment of the present invention;

FIG. 9 is a schematic diagram illustrating one example of a data display that may be provided by an application or browser in accordance with at least one embodiment of the invention;

FIG. 10 is a control flow diagram illustrating another example of a process for mapping records to projects in accordance with at least one embodiment of the invention;

FIG. 11 is a schematic diagram illustrating several examples of data hierarchies that may be constructed in accordance with at least one embodiment of the invention; and

FIG. 12 is a functional block diagram illustrating a computer system suitable for operation in accordance with at least one embodiment of the invention.

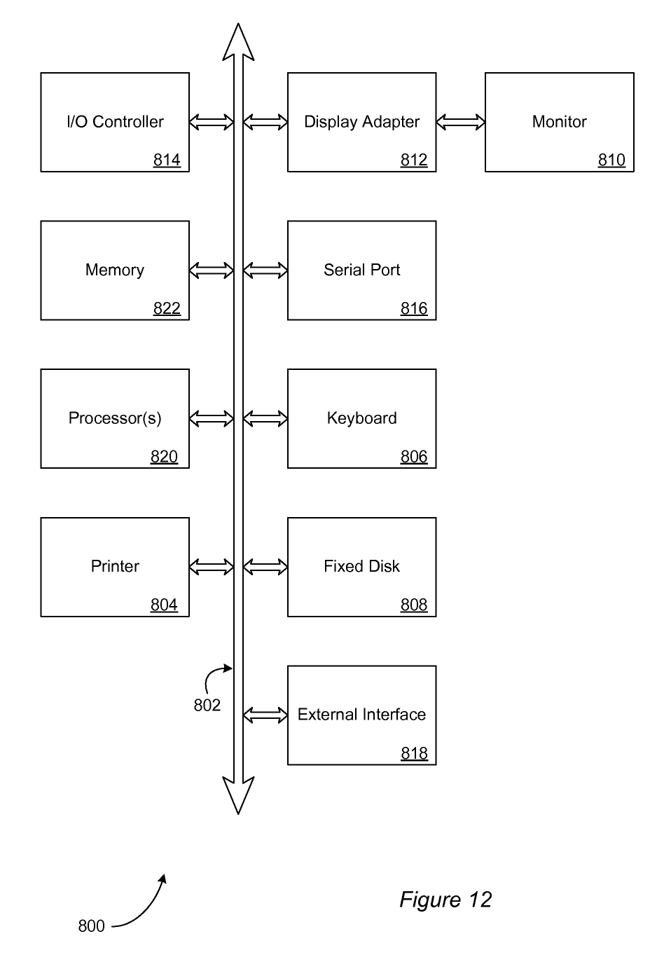

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc. that is part of a client device, server, or other form of computing device) that are programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

As used herein, the term web browser or web-based application generally refers to a software system having browser-based access such that an end user, or client, requires only a browser and an Internet/intranet connection on their desktop, laptop, tablet, network appliance, PDA, smartphone, etc., to obtain substantially complete access to that system. Many web-based information systems, including those described below with respect to the described embodiments, also accommodate so-called server-to-server communications in which automated systems, rather than humans, are the requesting clients. Commonly, the web-based business information systems sends information to the automated client, and/or receives information from the automated client, using HTTP or HTTPS over TCP/IP, with the data itself being presented according to a markup language such as XML or variants thereof such as qbXML or smbXML.

In an embodiment of a system in accordance with one aspect of the present invention, a central server collects project records from multiple disparate sources, normalizes the records, and maps the records to a particular project. The server may also analyze the records to determine a current status of the project. The server further provides an interface for presenting the project to a user in a unified manner. For example, the central server obtains records from a first database that pertain to projects and normalizes the records to identify the projects. The server obtains records pertaining to committed contracts corresponding to projects from a second database, normalizes the committed contract records and maps the normalized committed contract records to identified projects based on one or more fields of the normalized committed contract record. The server obtains records from a third database pertaining to task orders corresponding to at least one of committed contracts and projects, normalizes the task order contract records and maps the normalized task order records to at least one of a committed contract record and an identified project based on one or more fields of the normalized task order record.

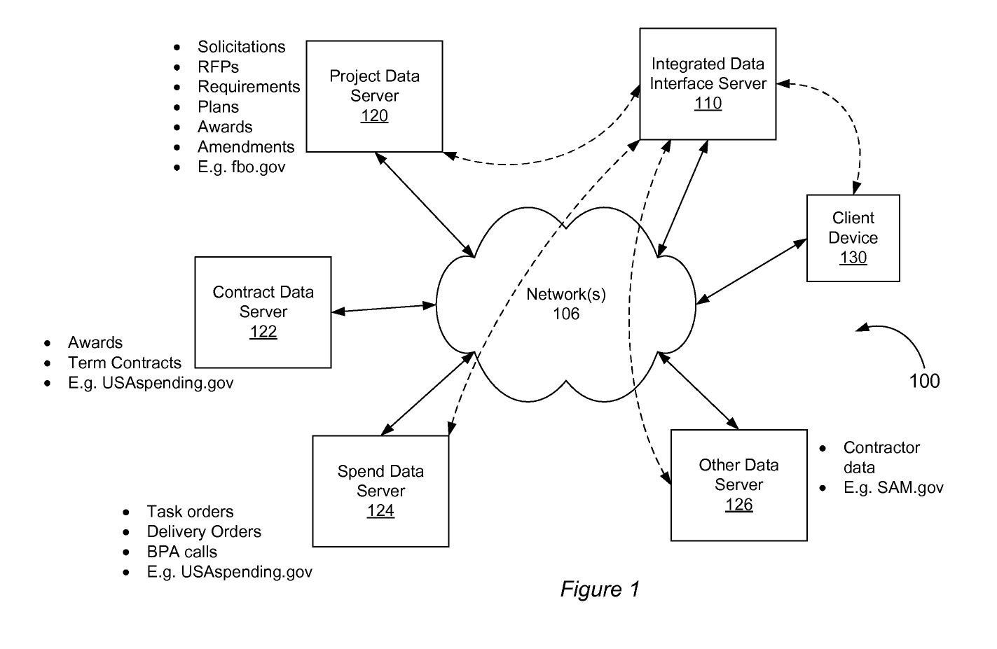

FIG. 1 is a schematic diagram depicting aspects of one example of a computing network architecture 100 in which an embodiment of the invention may be implemented. As shown, architecture 100 includes a network 106 that communicably couples integrated data interface server 110 to multiple disparate data servers 120, 122 and 124 having data pertaining to a project or contract. Examples of suitable networks 106 include networks utilizing wired and wireless communication technologies and networks operating in accordance with any suitable networking and/or communication protocol (e.g., the Internet).

In one example, project data server 120 maintains records for solicitations, requests for proposals (RFPs), requirements, plans, awards or amendments. Contract data server 122 maintains records for awards, such as purchase orders (POs) or stand alone Definitive Contract Agreements (e.g. DCAs), and term contracts relating to projects. Spend data server 124 maintains records of specific tasks committed to be performed for contracts, such as task orders or BPA calls. Other data servers, such as server 126, may be accessed to obtain data that may be useful with respect to projects, such as performance information about contractors.

Architecture 100 also illustrates client device 130 that may communicate with integrated data interface server 110 via network 106. For example, a client device may incorporate and/or be incorporated into a client application (e.g., software) implemented at least in part by one or more of the computing devices. One example of a client application is a web browser operating on client device 130. Examples of computing devices suitable for implementing client device 130 include personal computers, server computers, desktop computers, laptop computers, notebook computers, personal digital assistants (PDAs), smart phones, cell phones, and consumer electronic devices incorporating one or more computing device components such as one or more processors, central processing units (CPU), or controllers.

In view of the present disclosure, a person skilled in the art would be able to construct devices, software packages, or a combination of both that are capable of achieving the business data communication, presentation, input, and editing functionalities described herein without undue experimentation, using publicly available programming tools and software development platforms. When running in the user's browser, web pages generated according to the examples described herein implement a client-side application that dynamically presents business information to the user and dynamically communicates with the integrated data interface server 110.

The records from the different data servers 120, 122, 124, and 126 often feature complex relationships or incomplete references to the projects to which they pertain. Integrated data interface server 110 analyzes the records from these servers in order to establish their relationship, analyze the data, associate records with corresponding projects, and provides a user interface that presents an integrated view of the project data for a particular project.

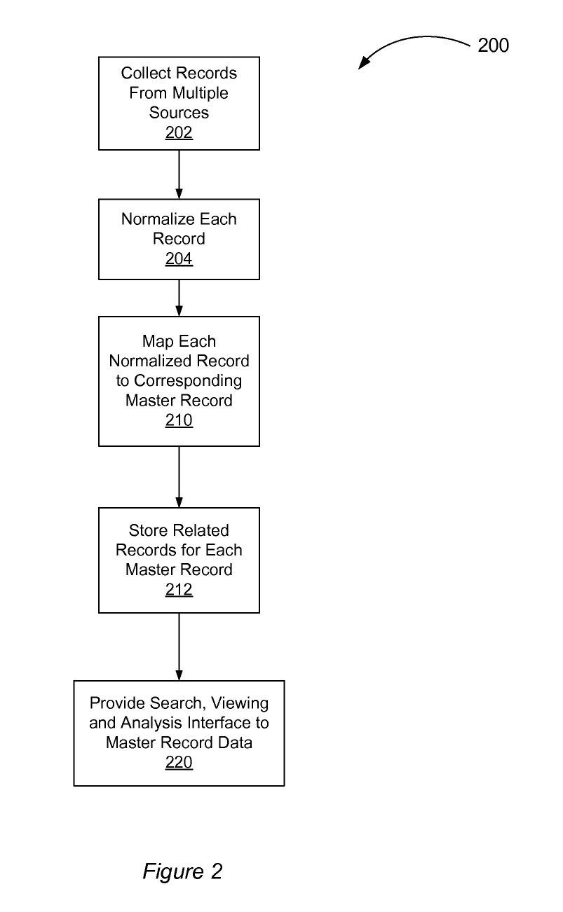

FIG. 2 is a control flow diagram illustrating an example of a process 200 that may execute in integrated data interface server 110 for collecting and mapping records to projects in accordance with at least one embodiment of the invention. At step 202, integrated data interface server 110 collects records pertaining to projects from multiple sources, such as servers 120, 122, 124, and 126. For example, solicitation records may be obtained from the servers at the Federal Business Opportunities site (fbo.gov), award, term contract, and task order records may be obtained from the servers at the USAspending.com site, and contractor and vendor data be obtained from the System for Award Management site (sam.gov). Examples of additional data records that may be collected and integrated are the Excluded Parties List System (EPLS), Central Contractor Registry (CCR), and Federal Agency Registration (Fedreg), which are also available from the sam.gov site. Another example is the state of Illinois, for which solicitation records may be obtained from www2.illinois.gov/cms/business/procurement while award records may be obtained from the State of Illinois Procurement Clearing House at procurementclearinghouse.illinois.gov/PPBClearinghouse/AwardSearch.apx. Other public and private entities may have data that is similarly stored in disparate sources.

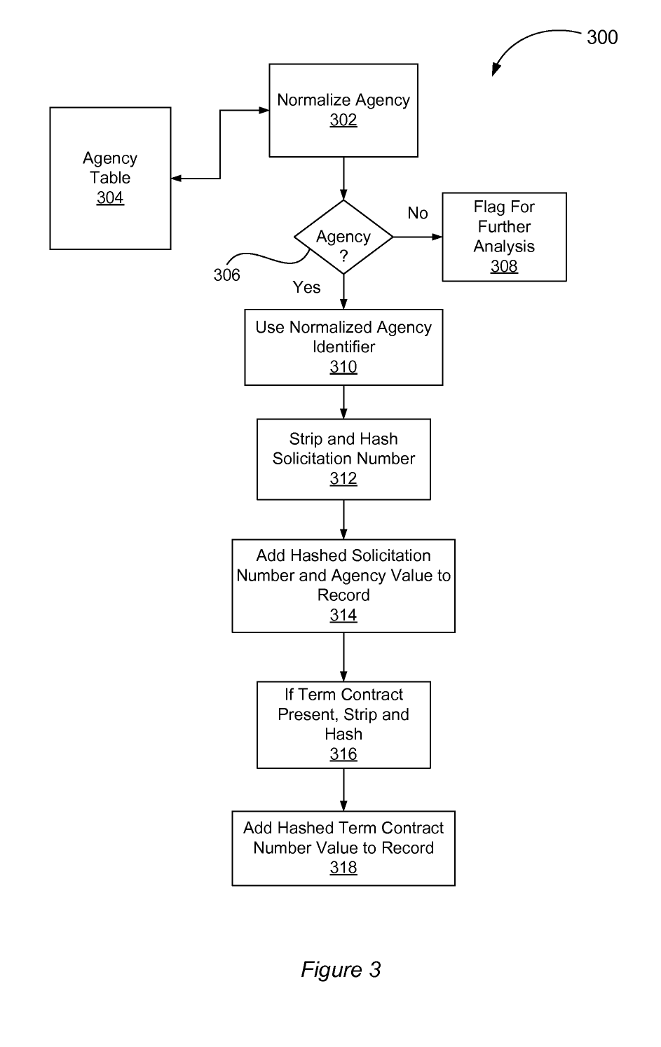

At step 204, portions of the collected records are normalized. Because records from different sources frequently utilize different data formats, certain embodiments of the present invention normalize at least some portions of the data in the records in order to place the data in a form that facilitates matching of records. An example of a normalization process is shown in FIG. 3.

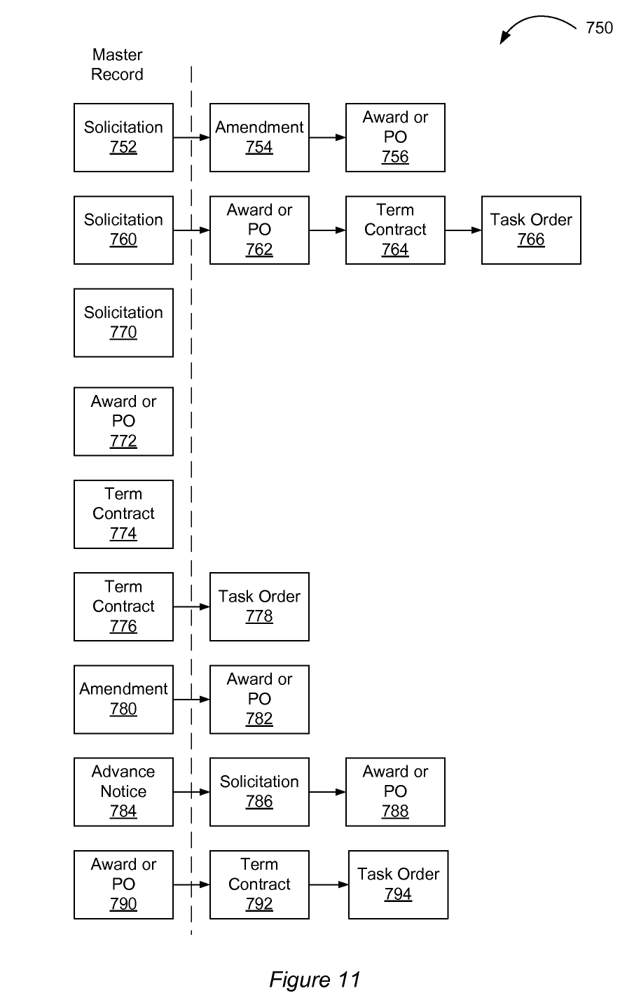

At step 210, the normalized data from the records is used to identify a corresponding master record. An example of a collected record that results in the creation of a master record is a solicitation obtained from fbo.gov. Other examples are illustrated in FIG. 11. A solicitation may have records of amendments, awards and various type of term contracts associated with it. For example, a normalized master contract value and a normalized agency value from a term contract record is used to search for a matching solicitation. In one example, an agency and a data field from a term contract record matches an agency and solicitation number in a master record. The term contract record is then associated with the master record. This may be done, for example, by extracting the record data and storing it at step 212 in storage that is accessible by unified data interface server 110. Alternatively, other linkages, such as Uniform Resource Identifiers (URIs), may be stored at step 212 with a master record in order to associate the records. One of ordinary skill in the art will recognize that there are many ways to associate these records with one another without departing from the scope of the invention. Similarly, a normalized term contract value obtained from a task order record, for example, may be used to search for a matching term contract and is associated with the matching term contract.

At step 220, a unified data interface is provided that permits a user to search, view and analyze the master record data collected, associated and stored above. For example, a user may search for solicitations of a particular type, e.g. using North American Industry Classification System (NAICS) codes, such as information, transportation and warehousing, or professional services. The interface may also provide a comprehensive and concise view of the data and information related to a particular solicitation through a unified interface that displays, for example, the awards, term contracts and task orders for the solicitation. Analysis tools may be provided that, for example, provide a timeline for activities, such as awards or term-contract dates, relating to a solicitation and track spending to date. The interface may provide further information or links to sources of information for the contractors, as well as the award and solicitation documents.

FIG. 3 is a control flow diagram illustrating one example of a process 300 for normalizing records in step 204 of the process 200 of FIG. 2 and in accordance with at least one embodiment of the invention. Solicitations are often identified by agency and solicitation number. At step 302, the agency that published the solicitation is normalized using agency table 304, which maps names and abbreviations to a normalized identifier, such as a unique numerical value or alphanumeric string. If no matching agency is found, then control branches at 306 to step 308, where the record is flagged for further analysis of the agency name and, if the agency can ultimately be identified, then, for example, the agency name will be added to agency table 304.

If the agency is identified, then control branches at 306 to step 310, where the normalized agency name replaces the value from the record for purposes of searching for matching records. At step 312, the solicitation number for the record is stripped of special characters, e.g. spaces, converted to all upper case or lower case characters, and the resulting text is hashed, i.e. the ASCII values for the characters are input to a hashing function that produces a corresponding value, along with the normalized agency identifier. At step 314, the hashed solicitation and agency value is added to the record. At step 316, if the record has a term contract identifier, then the term contract identifier is stripped and hashed in a manner similar to step 312 and, at step 318, the hashed term contract identifier is added to the record. The result is a record with normalized values for agency, solicitation identifier or term contract identifier that facilitate searching and matching to other pertinent records.

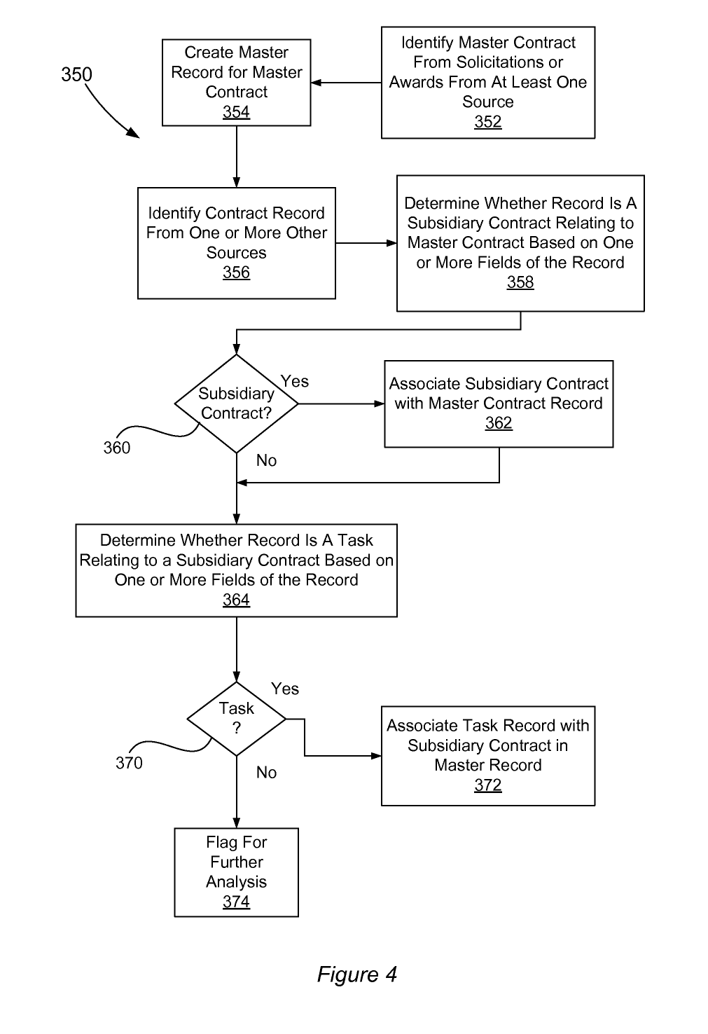

FIG. 4 is a control flow diagram illustrating one example of a process 350 for the mapping records to projects step 210 in the process 200 of FIG. 2 in accordance with at least one embodiment of the invention. At step 352, the master contracts, e.g. solicitations, from one or more sources, e.g. fbo.gov, are identified and, at step 354, a master record is created for an identified master contract. This may be done all at once or new master contracts are identified and added to a database for the records. At step 356, term contract records, such as FSS, GWAC or IDC contracts, are identified from another source, e.g. USAspending.gov, and, at step 358, the record is analyzed to determine whether it is a subsidiary contract relating to a master contract by examining other fields of the record. For example, a term contract record has its own contract identifier and a field containing the identifier for a corresponding master contract. If the record is for a subsidiary contract, e.g. a term contract, then control branches at step 360 to step 362, where the term contract record is associated with the master record. At step 364, the record is analyzed to determine whether it is a task relating to a term contract. For example, if the record is a task order, a field within the record that identifies the term contract is used to find the matching term contract record and is associated with the corresponding term contract record and the master record at step 372. If the process is unable to identify the nature of the record, then it is flagged for further analysis at step 374.

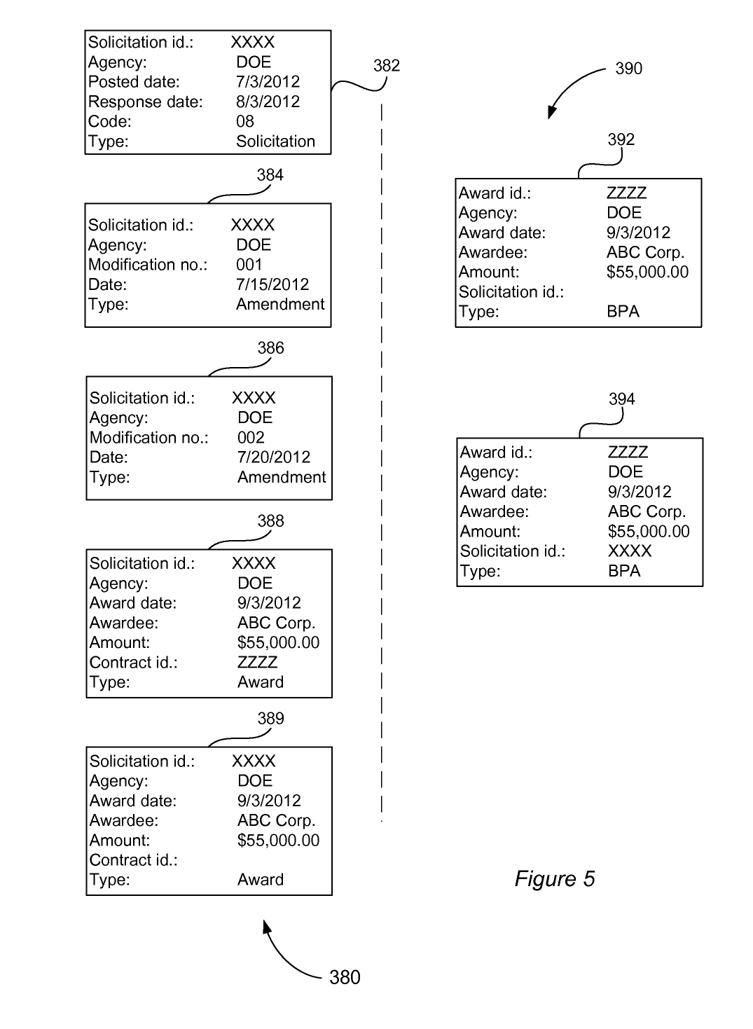

FIG. 5 is a schematic diagram illustrating examples of records that may be matched utilizing the process of FIG. 4. In FIG. 5, examples of records from a first source 380, such as fbo.gov, are shown with examples of term contract records from a second source 390, e.g. USAspending.gov, that may be matched in accordance with certain aspects of the present invention. Records from various sources may have incomplete or erroneous data or the records may not be directly associated, but may be associated via intervening records. For example, solicitation record 382 may not be matched directly to term contract record 392 because the solicitation identifier field of record 392 is not populated. By contrast, term contract record 394 does include the solicitation number, which permits the record to be associated with the master record corresponding to solicitation 382.

However, amendment records 384 and 386 as well as award record 388 may be matched to a master record created from solicitation record 382 based on the agency and solicitation number. Because award record 388 includes the contract identifier “ZZZZ”, term contract record 392 may be associated with award record 388 based on the award identifier and, because award record 388 is associated with the master record for solicitation record 382, term contract record 392 may be associated with solicitation record 382.

In a more complex example, award record 389 has a solicitation identifier value that allows it to be associated with solicitation record 382, but is missing a value for contract identifier. However, in accordance with certain embodiments, record 389 can be matched to term contract record 392 by matching the values for agency, awardee, award date and award amount. Term contract record 392 may then be associated with award record 389 and, by extension, the master record corresponding to solicitation record 382.

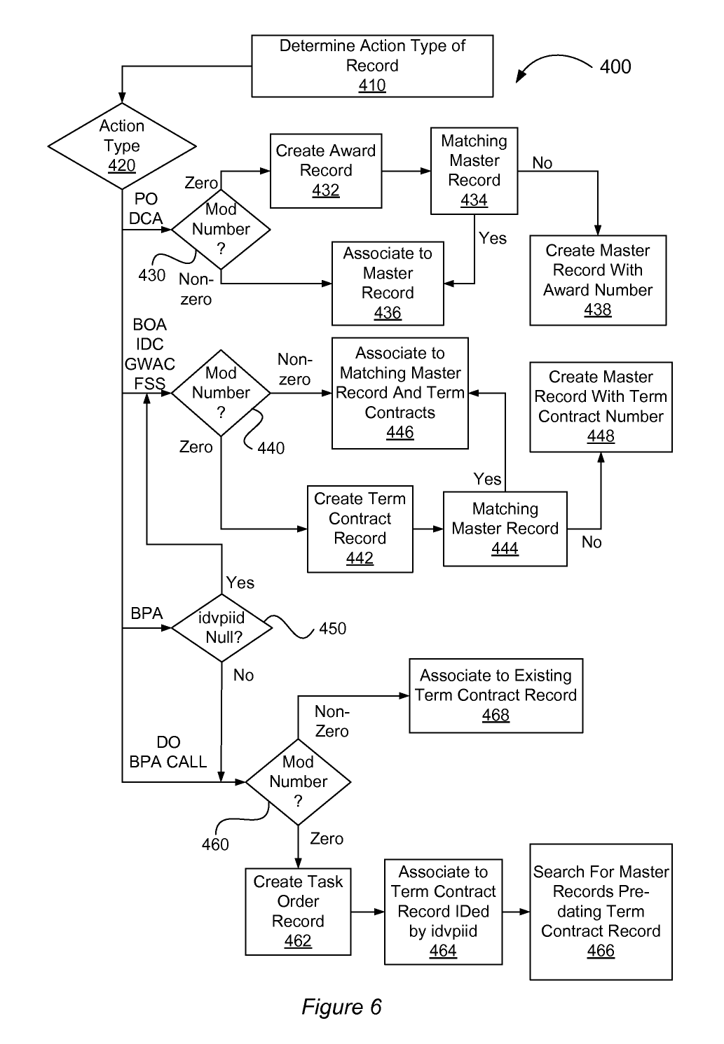

FIG. 6 is a control flow diagram illustrating an example of a process 400 for mapping records from USAspending.gov to master records derived from records sourced from fbo.gov in accordance with at least one embodiment of the invention. When a record is analyzed, an action type is checked and control branches at step 420 based on the action type of the record. Federal action types typically include: purchase order (PO); definitive contract agreement (DCA); indefinite delivery contract (IDC); basic ordering agreement (BOA); government wide acquisition contract (GWAC); federal supply schedule (FSS); blanket purchase order (BPO); delivery order (DO); and blanket purchase agreement call (BPA CALL). Records from USAspending.gov will normally use these types for spending records.

If the record is PO or DCA, then the record is an award record and, at step 430, the mod number field of the record is checked. If the mod number is non-zero, then the record is an amendment or modification, which is associated or linked with an existing master record corresponding to the solicitation identifier value of the record at step 436. Because the record is a modification, there will typically be a corresponding master record.

If the mod number is zero, then the record is an award and control branches to step 432 to create an awardt record for the contract identifier value from the original source record, e.g. piid in USAspending.com, that will allow amendments to be associated with the master record. The award record may include data from the original source record, such as the transaction obligated amount (obligatedamount), transaction committed amount (baseandexercisedoptionsvalue), transaction ceiling (baseandalloptionsvalue), effective date, and the ultimate completion date. At step 434, a search is performed for a master record corresponding to the solicitation identifier value. If an existing master record is found, then control branches to step 436, where the award record is associated with the matching master record. If no matching master record is found, then a master record is created at step 438 using the award identifier from the government record.

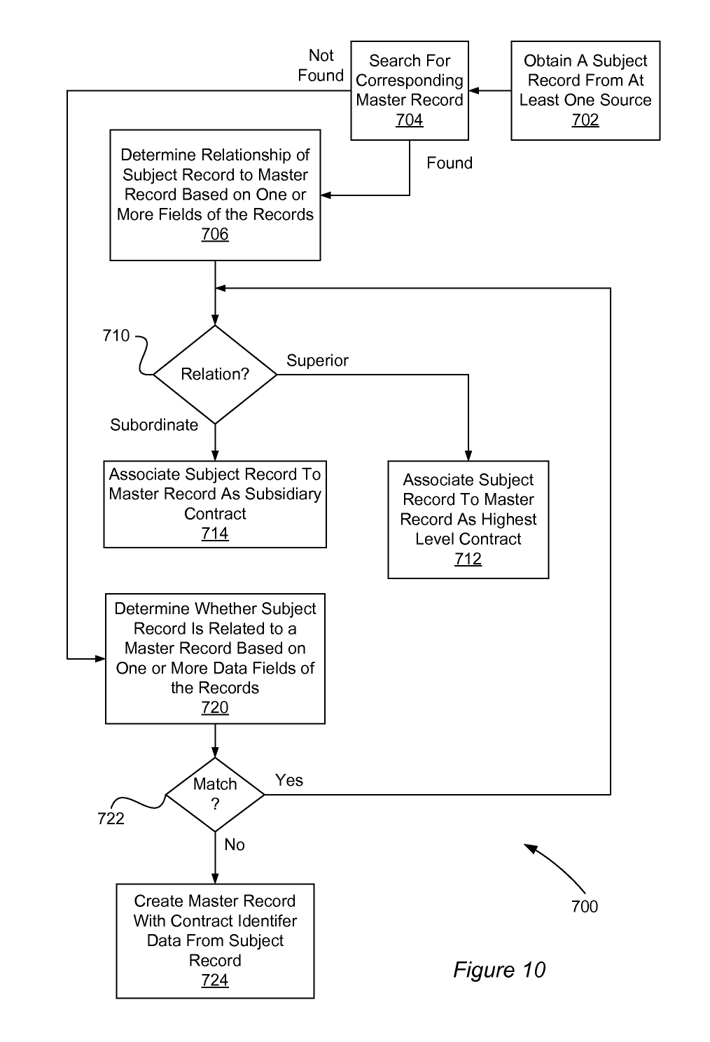

An example of the result at this stage of processing is illustrated in FIG. 11 regarding record 772, where an award record has been used to generate a master record. As other related records are subsequently identified, both superior and subordinate records will be associated to the master record to create a related hierarchy of data using the process 700 of FIG. 10, for example. This allows the hierarchy to be gradually constructed from the source records as the source records are analyzed. For example, when a solicitation record is processed that matches with the data from the award record, the solicitation record is associated with the master record, the master record is updated with the solicitation identifier value, and the award record is associated with the solicitation record, as demonstrated by the relationship of solicitation record 760 to award record 762 in FIG. 11. Term contract record 764 and task order record 766 may have been associated with the award record 762 before the matching solicitation record was identified or afterwards.

The master record may also contain summary data related to the contract, such as the contract obligated amount (sum of obligatedamount from all associated task order records or amendments), contract committed amount (sum of baseandexercisedoptionsvalue from all associated term contract and task records), and contract ceiling (sum of baseandalloptionsvalue from all associated term contract records) for all the awards, modifications, term contracts and task orders related to the master contract number. The master record may also include a count of the number of task orders. As records are associated or linked to a master contract record, the amounts, e.g. obligatedamount, from these records are added to the corresponding summary fields, e.g. term contract obligated amount=sum of obligatedamount values.

Additional information stored in the master record may include identifiers for industries & sub-industries, NAICS codes (principalnaicscode), PSC codes (productorservicecode), and set-aside codes (typeofsetaside). In one example, this data may be obtained from the most recently dated term contract record associated with the master record.

If the action type is BOA, IDC, GWAC or FSS, then control branches to step 440, where the mod number field is checked. If the mod number value is non-null, then the source record is an amendment or modification and control branches to step 446, where the record is associated with a matching master record. If the mod number is zero, then the source record is a term contract and control branches to step 442 and a term contract record is created using the contract identifier, e.g. piid in a USAspending.com term contract record. At step 444, a search is performed for a matching master record, e.g. using the piid value. If a matching master record is found, then control branches to step 446 where the newly created term contract record is associated with the master record. If no matching master record is found, then control branches to step 448 where a master record is created using the data from the source term contract record, e.g. the piid from USAspending.com. The master record produced from term contract record 774 in FIG. 11 is an example of the data structure that may be exist at this point in processing. In subsequent processing, task order records may be associated with the term contract record and master record, as illustrated by data structure including term contract record 776 and task order record 778 in FIG. 11. Also, an award record may be associated with the term contract record and the master record, resulting in the data structure involving award record 790, term contract record 792 and task order record 794 in FIG. 11.

If the action type is BPA, then control branches to step 450 to check the idvpiid field, which identifies any associated term contract in federal contracts. If idvpiid is null, then the source record pertains to a term contract and control flow branches to step 440, where the record is processed as a term contract in the manner described above. If the idvpiid value is non-null, then the source record is a BPA task order record pertaining to the term contract identified in the idvpiid field and control flow branches to step 460 for processing as a task order, which is described below.

If the Action Type is DO or BPA CALL, then control branches at step 420 to step 460, where the source record is processed as a task order and is associated or linked with the term contract record identified in a data field in the task record, e.g. idvpiid for federal contracts. At step 460, the mod number is checked and, if the mod number is non-zero, then the source record is an amendment and control branches to step 468 where the task order is associated with the term contract record identified within the source record, e.g. in the idvpiid field. If the modification number is zero, then the source record represents a new task order and control branches to step 462, where a task order record is created using a task identifier value from the source record, e.g. the piid field in a task order. The task order record is then associated with the term contract record identified within the source record, e.g. idvpiid and, at step 466, a search is performed to find a master record predating the term contract record with which to associate the task record.

Note that multiple task records are often associated with a term contract. For example, a BPA term contract record may have multiple BPA CALL task order records linked to it that document the committed spending for the BPA term contract. An IDC term contract record may have multiple DO task records linked to it that document the committed spending for the IDC term contract. In one embodiment, summary data for a master record is updated as each task order record is associated with the master record. For example, in the federal contract context, the obligatedamount, baseandexercisedoptionsvalue, and baseandalloptionsvalue fields of the task records are added to the corresponding summary totals in the master contract record.

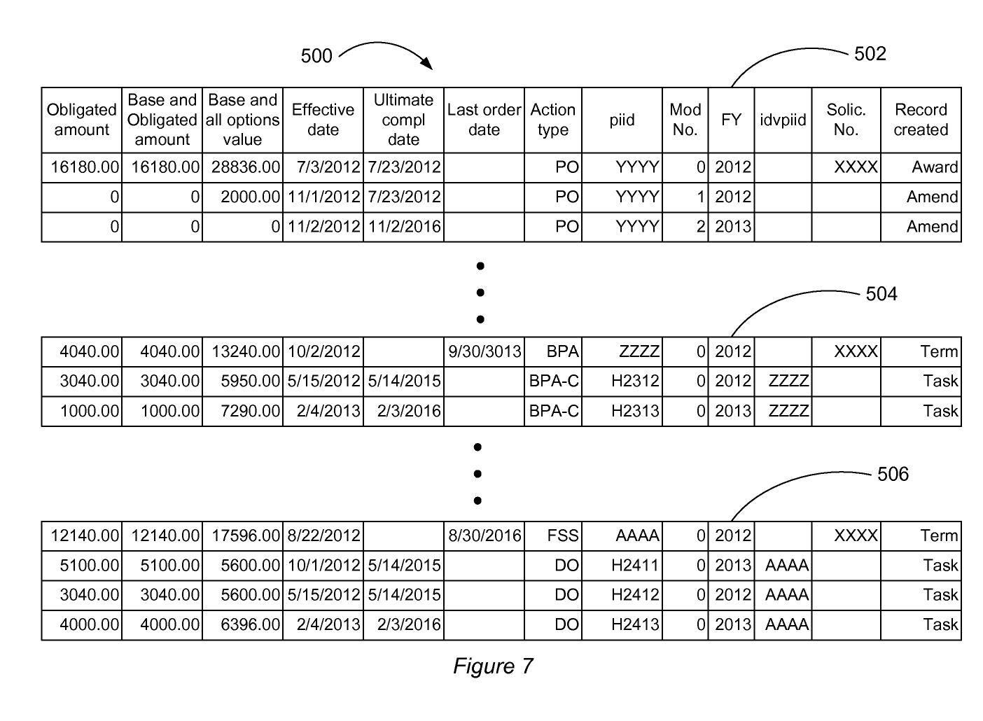

FIG. 7 is a schematic diagram illustrating examples of a record data 500 that may be processed and structured in accordance with some aspects of the present invention. In the diagram, database 500 includes a first example 502 having a first row with a value in the Action Type column of “PO”, a piid value of “YYYY”, and the “Mod Number” is zero. As described above with respect to FIG. 6, the first row is an award and will be processed by creating an award record with the record number from the piid field of “YYYY” and linking it to a master record, if one exists for the solicitation identifier value “XXXX”, if it exists. If no master record exists for “XXXX”, then a master record is created using the piid value of “YYYY”. Second and third rows in database 500 have a piid value of “YYYY” and Mod numbers of 1 and 2, respectively. These are amendments to the award of the first row and are linked to the award record for “YYYY” and the associated master record for XXXX, if it exists.

A second example 504 of record data 500 has a first row with an Action Type of “BPA” and a null idvpiid, which means that the record is a term contract. A search is performed for a master record corresponding to the solicitation identifier value “XXXX” for the term contract record. If a matching master record is found, then the term contract record for contract “ZZZZ” is associated with the master record. If no matching master record is found, then a master record is created using the term contract record data, e.g. piid=“ZZZZ”. This search may include a search for associated term contracts and corresponding lifecycles having the same piid value. The next two rows of example 502 have values for piid H2312 and H2313, respectively, an Action type of BPA-C, e.g. BPA CALL, and non-null idvpiid values of “ZZZZ”. These rows are processed as task order records and linked to the term contract record for ZZZZ. Also, the obligated amount, base and obligated amount, and base and all options value amounts are added to the summary data for the master record and the latest last order date is added to the master record.

A third example 506 of record data has a first row with a piid value of AAAA, an Action Type of “FSS” and a last order date of Aug. 30, 2016, which means that the record is FSS term contract. This row is processed as a term contract record for contract “AAAA” in a manner similar to the example 504 above. There are also three rows of example data records 506 for piid H2411, H2412, and H2413, which have null last order date, an Action type of DO CALL, and idvpiid values of “AAAA”. These rows are processed as task order records, linked to the term contract for AAAA and their amount values added to the summary values for the master record.

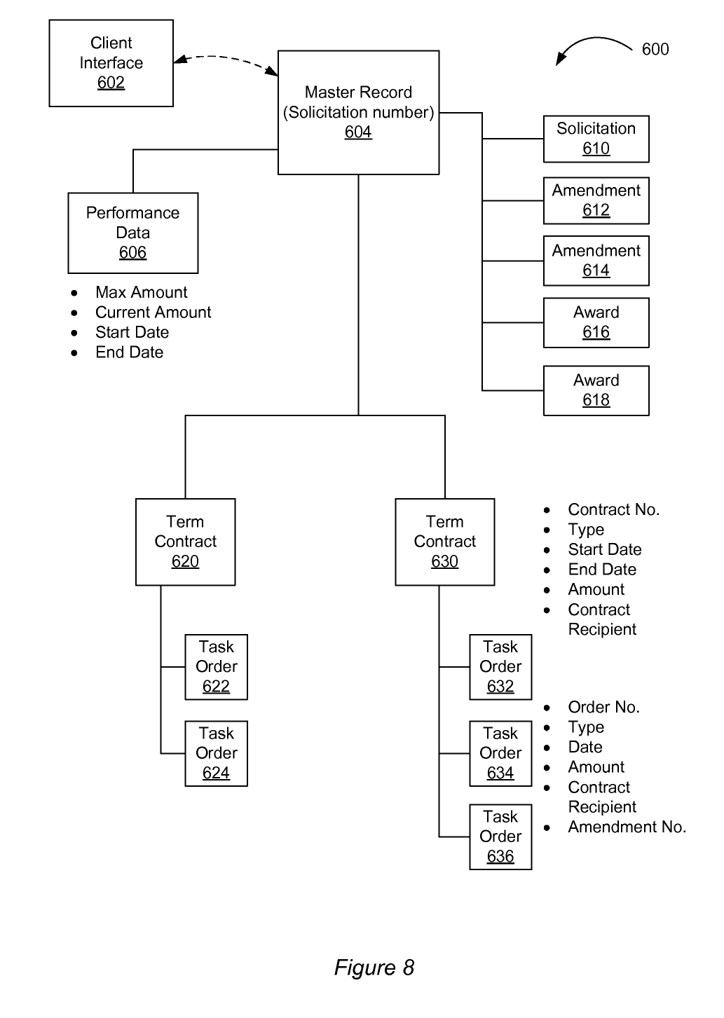

FIG. 8 is a schematic diagram illustrating an example of a master contract record structure 600 that may result from the processes described herein and may be accessed using client interface 602. A master record 610 is identified with solicitation number “XXXX” and has a solicitation record 610 for XXXX associated with it along with two amendment records 612 and 614 and award records 616 and 618. In this example, master record 610 also has performance data 606 associated with it, such as the maximum billable amount of the contract, the currently committed spending amount, and the start and end dates for the contract. The master contract has a first term contract record 620, which, in this example, corresponds to the first row of data records 504 of FIG. 7 for term contract number “ZZZZ”, and a second term contract record 630, which corresponds to the first row of data records 506 for term contract number “AAAA”, associated with it that identify, in this example, the term contract number, the action type, the start and end dates, the total amount of the contract and a contract award recipient. This diagram illustrates one example of a project lifecycle where records are linked together based upon similarities in project identifier field values, e.g. solicitation id, piid, idvpiid.

Each of the term contracts, in this example, has the task orders associated with it that indicate what spending has been committed under the term contract. Term contract 620 has two task orders associated with it: 622 and 624, which correspond to the task order rows of records 504 in FIG. 7. Similarly, term contract record 630 has three task orders 632, 634 and 636 associated with it, which correspond to the task order rows of database portion 506 from the database example of FIG. 7. In this example, each task order has an order number, an order type, a date, an amount, a contract recipient, and an amendment number.

Client interface 602 permits the data in record structure 600 to be viewed and analyzed in a concise, organized hierarchical manner and may include analytical data. Client interface 602 will display the term contracts associated with the master contract and will permit the task orders associated with each term contract to be viewed in relationship to the term contract. The performance data for the master contract is provided in this example so that the maximum amount of the master contract can be viewed along with the current amount of spending obtained from summing the amounts of all the task orders associated with the master contract.

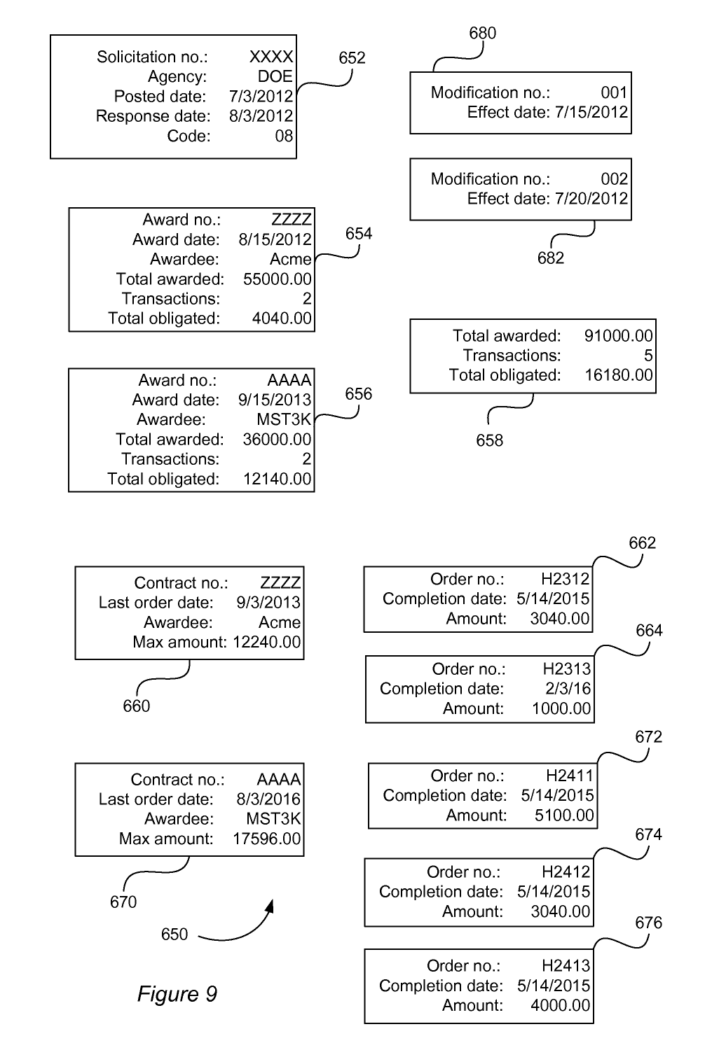

FIG. 9 is a schematic diagram illustrating one example of a data display 650 that may be provided for client interface 602. This display data may, for example, be provided by the system as an interface for a web browser or a client application in accordance with one aspect of the present invention. Data for master record “XXXX” is displayed in window 652, which, in this example, includes a solicitation identifier and the contracting agency, the latest ultimate completion date from the amendments, and the NAICS code. Two amendment records are displayed in windows 654 and 656 and contain data such as effective date. Display window 658 shows performance data, such as the total amount awarded under the solicitation XXXX, the total amount of spending that is committed in the task orders corresponding to the master record, and the number of transactions, e.g. task orders, for the solicitation. Windows 680 and 682 show modification and amendment data.

Display windows 660 and 670 each show data for term contracts “ZZZZ” and “AAAA” because the term contract records were linked or associated with master record for solicitation “XXXX”. Display windows 660 and 670 provide data for each term contract, such as the contract identifier, the amount of the term contract, the last order date, and awardee data, such as an identifier or a link to the contractor awarded the contract. In addition, the display shows the task order records for each term contract in relation to the term contract record with which they're linked or associated. Task order record windows 662 and 664 are illustrated as being related to term contract window 660 and include the task order identifier, the amount, and the completion date for each task. Similarly, task order record windows 672, 674 and 676 are illustrated as being related to term contract window 670. The sum of the amounts shown in task order record windows 662, 664, 672, 674 and 676 is displayed in a field of display window 658 representing the committed spending to date along with a count of the number of transactions, e.g. task orders, under the contract. In one example, the term contract windows are shown in descending date order with respect to the master contract and the task orders are shown in descending date order with respect to each corresponding term contract. A timeline analysis window may also be provided that places each of the records displayed in overall chronological relationship to one another.

In the systems and methods described herein, a user of the interface data shown in interface 650 is able to quickly understand the history of a project or master contract, e.g. solicitation XXXX, from solicitation, through amendment, award and term contracting through to the individual task orders and appreciate the relationships and the activity for the master contract. Analysis tools may also be provided that display the data from disparate records in a manner that permits the user to understand the current state of spending on the master contract. Additional data or links may be provided that permit a user to readily examine the contractor information of the awardees or the agency information for the awarding agency or entity. Organizing the data in the manner described herein may also permit master contracts to be readily searched and analyzed, e.g. search for all Department of Transportation master contracts having the NAICS code for professional services.

FIG. 10 is a control flow diagram illustrating another example of a process 700 for processing project records that provides for associating records that are higher or lower in a hierarchy for a project lifecycle. At step 702, a subject record is obtained from a record source, e.g. USAspending.gov. At step 704, the data from the subject record is used to search for a corresponding master record. At step 706, the relationship between the subject record and the master record and other associated records is determined. If the subject record is hierarchically superior to the record from which the master record is generated, then, at step 712, the subject record is associated with the master record in a higher relationship than the previous record and data from the subject record populates the master record. In a sense, the subject record becomes the master record. For example, if the master record was created from a term contract record, e.g. term contract record 776 with associated task order record 778 in FIG. 11, and the subject record is an award record corresponding to the contract, then the subject record is associated with the master record in a hierarchical position that is superior to the term contract record, e.g. award record 790, term contract record 792 and task order 794.

Similarly, if the subject record is hierarchically subordinate to the master record, then, at step 710, it is associated with the master record in a lower hierarchical position. For example, the term contract record 774 in FIG. 11 was used to create the master record. If a task record is associated with a term contract, the task record is subordinate to the term contract in the hierarchy, as illustrated in the example of term contract record 776 and task order record 778 in FIG. 11.

If no corresponding master record can be identified at step 704, control branches to step 720, where auxiliary data from the subject record is used to attempt to find a matching master record. Returning one of the examples of FIG. 5, the agency identifier, award date, awardee, and amount data from term contract record 392 is used to find a match in award record 389. If a match can be determined using auxiliary data, then control flow branches to step 710 for the subject record to be associated with the hierarchy of the master record. If no match is found, then control branches to step 724, where a master record is created from the data from the subject record.

FIG. 11 is a schematic diagram illustrating examples of master record hierarchies that may arise in constructing a database of project data using records from disparate sources. The first column represents master records for each hierarchy. Often, a data structure will be based off a solicitation record, such as the solicitation records 752, 760 and 770. The master record based on the solicitation record may contain only the solicitation record data if it is the first project record processed or no award or other activity has occurred, as illustrated by solicitation record 770. If amendment and award activity has occurred and the records for that activity are processed, then the structure of solicitation record 752 associated with amendment record 754 and award record 756 may arise. The structure related to solicitation record 760 shows a relatively complete lifecycle relationship, with award record 762 associated with the master record along with term contract record 764 and task order 766.

As discussed above, intermediate structures may arise during processing that allow a project lifecycle data structure to be progressively constructed. For example, a term contract record with no matching master record created as a result of a solicitation or award record may result in a master record being created for the term contract record, e.g. term contract record 774. If a subordinate record, such as a task order, corresponding to the term contract record is processed, then it is associated with the master record from the term contract record, e.g. term contract record 776 and task order record 778. If an award record corresponding to the term contract is processed, then the award record is inserted into the hierarchy above the term contract and replaces the term contract record as the master record, e.g. award record 790, term contract record 792 and task order record 794. When the corresponding solicitation record is processed, then the solicitation record takes over as master record, e.g. solicitation record 760, award record 762, term contract record 764 and task order record 766. Other examples are provided in FIG. 11, but these examples are non-exhaustive and other structures can arise.

In accordance with at least one embodiment of the invention, the system, apparatus, methods, processes and/or operations for project information management may be wholly or partially implemented in the form of a set of instructions executed by one or more programmed computer processors, such as a central processing unit (CPU) or microprocessor. Such processors may be incorporated in an apparatus, server, client or other computing device operated by, or in communication with, other components of the system.

As an example, FIG. 9 depicts aspects of elements that may be present in a computer device and/or system 800 configured to implement a method and/or process in accordance with some embodiments of the present invention. The subsystems shown in FIG. 9 are interconnected via a system bus 802. Additional subsystems include a printer 804, a keyboard 806, a fixed disk 808, and a monitor 810, which is coupled to a display adapter 812. Peripherals and input/output (I/O) devices, which couple to an I/O controller 814, can be connected to the computer system by any number of means known in the art, such as a serial port 816. For example, the serial port 816 or an external interface 818 can be utilized to connect the computer device 800 to further devices and/or systems not shown in FIG. 8 including a wide area network such as the Internet, a mouse input device, and/or a scanner. The interconnection via the system bus 802 allows one or more processors 820 to communicate with each subsystem and to control the execution of instructions that may be stored in a system memory 822 and/or the fixed disk 808, as well as the exchange of information between subsystems. The system memory 822 and/or the fixed disk 808 may embody a tangible computer-readable medium or persistent storage device, such as magnetic disc, EEPROM, flash memory, or RAM memory supported by a power source.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++, or Perl using, for example, conventional or object-oriented techniques. The software code may be stored as a series of instructions or commands on a computer readable medium, such as a random access memory (RAM), a read-only memory (ROM), a magnetic medium such as a hard-drive, a solid-state device such as a flash memory drive, or an optical medium such as a CD-ROM. Any such computer readable medium may reside on or within a single computation al apparatus, and may be present on or within different computational apparatuses within a system or network.

Different arrangements of the components depicted in the drawings or described above, as well as components and steps not shown or described are possible. Similarly, some features and sub-combinations are useful and may be employed without reference to other features and sub-combinations.

Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A project information management system comprising one or more servers communicatively coupled to a computer communication network, the system being configured to:
communicate with a plurality of services through the network to collect multiple records from disparate databases, where the multiple records relate to project information;
normalize the collected records to a predetermined data format;
for each normalized collected record, analyze multiple fields of the record to identify a type for the record and identify search values for searching for a related record, search for one or more related records, and, for each related record is found, associate the record with the related record;
store the records and their association with one another to facilitate retrieval of the records and their associations; and
provide an interface to the stored records that is configured to display, for a selected record, the record, the associated records, and the relationships between the records.

2. The project information management system of claim 1, wherein:
the types for the records include at least one of a solicitation, an amendment, an award, a term contract, and a task order; and
the system is further configured to store the records and their association with one another by storing each term contract record with the term contract record's association with a master contract record and storing each task order record with the task record's association with at least one of a master contract and a term contract.

3. The project information management system of claim 2, wherein the associations between records are stored as one of a link from one record to another, a hierarchical data structure, and a relational database.

4. The project information management system of claim 2, wherein the interface to the stored records is further configured to:
provide access to a selected master contract record along with at least one of an associated amendment record, award record, and term contract record; and
provide access to at least one task record associated with an associated term contract records.

5. The project information management system of claim 4, wherein the interface to the stored records is still further configured to:
display in a hierarchical manner the selected master contract record along with one or more of the associated amendment record, award record, and term contract record; and
display in a hierarchical manner the task record data associated with the associated term contract record.

6. The project information management system of claim 5, wherein the system is further configured to:
sum a spending amount committed in each task record for all the task records associated with the selected master contract record through associated term contract records; and
display the summed spending total for the selected master contract record.

7. The project information management system of claim 4, wherein the interface to the stored records is still further configured to provide access to contractor data, agency data, and contract documents associated with one or more of a master contract record, an amendment record, an award record, a term contract record, and a task order record.

8. The project information management system of claim 1, wherein the multiple fields of the record analyzed to identify a type for the record and identify search values for searching for a related record include at least one of an action type, a contract date, an agency identifier, a project identifier field, a secondary project identifier field, a solicitation identifier field, an amount field, and an awardee identifier field.

9. A method for project information management, the method comprising the steps of:
communicating with a plurality of services through a computer communication network to collect multiple records from disparate databases, where the multiple records relate to project information;
normalizing the collected records to a predetermined data format;
for each normalized collected record, analyzing multiple fields of the record to identify a type for the record and identify search values for searching for a related record, search for one or more related records, and, for each related record is found, associate the record with the related records;
storing the records and their association with one another to facilitate retrieval of the records and their associations; and
providing an interface to the stored records that is configured to display, for a selected record, the record, the associated records, and the relationships between the records.

10. The project information management method of claim 9, wherein:
the types for the records include at least one of a solicitation, an amendment, an award, a term contract, and a task order; and
the step of storing the records and their association with one another further comprises storing each of the solicitation record, the amendment record, the award record, the term contract record and the task order record in a hierarchical manner.

11. The project information management method of claim 10, wherein the associations between records are stored as one of a link from one record to another, a hierarchical data structure, and a relational database.

12. The project information management method of claim 10, wherein the step of providing an interface to the stored records further comprises:
providing access to a selected master contract record along with at least one associated amendment record, award record, and term contract record; and
providing access to at least one task record associated with the associated term contract record.

13. The project information management method of claim 12, wherein the step of providing an interface to the stored records further comprises:
displaying in a hierarchical manner the selected master contract record along with the associated term contract record; and
displaying in a hierarchical manner the task record data associated with the associated term contract records.

14. The project information management method of claim 13, the method further comprising:
summing a spending amount committed in each task record for all the task records associated with the selected master contract record through all associated term contract records; and
displaying the summed spending total for the selected master contract record.

15. The project information management method of claim 12, wherein the step of providing an interface to the stored records further comprises providing access to contractor data, agency data, and contract documents associated with one or more of a master contract record, a term contract record, and a task order.

16. The project information management method of claim 9, wherein the multiple fields of the record analyzed to identify a type for the record and identify search values for searching for a related record include at least one of an action type, a contract date, an agency identifier, a project number field, and a secondary project number field.

17. One or more computer-readable storage media having stored therein computer-readable instructions that when executed by a computer cause the computer to perform a method for project information management, the method comprising the steps of:
communicating with a plurality of services through a computer communication network to collect multiple records from disparate databases, where the multiple records relate to project information;
normalizing the collected records to a predetermined data format;
for each normalized collected record, analyzing multiple fields of the record to identify a type for the record and identify search values for searching for a related record, search for one or more related records, and, for each related record that is found, associate the record with the related record;
storing the records and their association with one another to facilitate retrieval of the records and their associations; and
providing an interface to the stored records that is configured to display, for a selected record, the record, the associated records, and the relationships between the records.

18. The one or more computer-readable storage media of claim 17, wherein:
the types for the records include at least one of a solicitation, an amendment, and award, a term contract, and a task order; and
the step of storing the records and their association with one another further comprises storing each term contract record with the term contract record's association with a master contract record and storing each task order record with the task record's association with at least one of a master contract and a term contract.

19. The one or more computer-readable storage media of claim 18, wherein the associations between records are stored as one of a link from one record to another, a hierarchical data structure, and a relational database.

20. The one or more computer-readable storage media of claim 18, wherein the step of providing an interface to the stored records further comprises:
providing access to a selected master contract record along with at least one associated term contract record; and
providing access to at least one task record associated with the associated term contract records.

21. The one or more computer-readable storage media of claim 20, wherein the step of providing an interface to the stored records further comprises:
displaying in a hierarchical manner the selected master contract record along with the associated term contract record; and
displaying in a hierarchical manner the task record data associated with the associated term contract records.

22. The one or more computer-readable storage media of claim 21, the method further comprising:
summing a spending amount committed in each task record for all the task records associated with the selected master contract record through associated term contract records; and
displaying the summed spending total for the selected master contract record.

23. The one or more computer-readable storage media of claim 20, wherein the step of providing an interface to the stored records further comprises providing access to contractor data, agency data, and contract documents associated with one or more of a master contract record, an amendment record, an award record, a term contract record, and a task order

24. The one or more computer-readable storage media of claim 17, wherein the multiple fields of the record analyzed to identify a type for the record and identify search values for searching for a related record include at least one of an action type, a contract date, an agency identifier, a project number field, and a secondary project number field.
